(19) United States
(12) Patent Application Publication
(10) Pub. No.: US 2024/0015027 A1
(43) Pub. Date: Jan. 11, 2024

(54) DATA PROVISION METHOD, SENSOR NETWORK AND SENSOR

(71) Applicant: ETO MAGNETIC GmbH, Stockach (DE)

(72) Inventors: Benjamin Bönisch, Bodman-Ludwigshafen (DE); Tobias Plötzing, Bodman-Ludwigshafen (DE); Sharang Parnerkar, Stockach (DE)

(21) Appl. No.: 18/252,281

(22) PCT Filed: Nov. 11, 2021
(86) PCT No.: PCT/EP2021/081367

§ 371 Date: May 9, 2023

(30) Foreign Application Priority Data
Nov. 13, 2020 (DE) 10 2020 130 087.5

(51) Int. Cl. H04L 9/32; H04L 9/08

(52) U.S. Cl. CPC H04L 9/3247; H04L 9/0819

(57) ABSTRACT

A data provision method includes a data provision step in which electronic data are generated by at least one data generation device, and includes a provision step in which the electronic data are provided in the form of data packages via a data transmission network, wherein in the provision step the data packages are first of all, preferably directly, written into a blockchain or into a distributed ledger, and wherein in the provision step the data packages are provided, preferably directly, from the blockchain or from the distributed ledger via the data transmission network, wherein provided data packages include at least one encrypted and/or digitally signed data field with a reference to an, in particular random or quasi-random, subsequent address of the next data package following the data package.

### CROSS REFERENCE TO RELATED APPLICATIONS

This application is a U.S. national stage application of PCT/EP2021/081367 filed on Nov. 11, 2021, which claims priority from and incorporates herein by reference the German patent application DE 10 2020 130 087.5 filed on Nov. 13, 2020.

### PRIOR ART

The invention concerns a data provision method, a sensor network and a sensor.

It has already been proposed that sensor data are deposited in blockchains or distributed ledgers in a manipulation-safe manner.

The objective of the invention is in particular to provide a data transmission method with advantageous properties regarding verifiability of transmitted data and/or regarding access control of transmitted data. The objective is achieved according to the invention.

### Advantages of the Invention

The invention is based on a data provision method, with a data generation step in which electronic data are generated by at least one data generation device, and with a provision step in which the electronic data are provided in the form of data packages via a data transmission network, wherein in the provision step the data packages are first of all, preferably directly, written into a blockchain or into a distributed ledger, in particular via the data transmission network, and wherein in the provision step the data packages are provided, preferably directly, from the blockchain or from the distributed ledger via the data transmission network.

It is proposed that data packages, in particular data packages provided in the provision step, preferably each data package provided in the provision step, comprise/s at least one data field which is, in particular cryptographically and/or electronically, encrypted and/or digitally signed, with a reference to an, in particular random or quasi-random, subsequent address of the next data package following the data package. This advantageously allows achieving real-time verifiability (digital signature) of provided data, in particular of a data stream comprising consecutive data packages, and/or real-time access control (encryption) for provided data, in particular the data stream. Advantageously a high level of data security is achievable, in particular with regard to a verification of authenticity of consecutively provided data packages and/or with regard to an access control of the consecutively provided data packages. Advantageously this enables a decentralized data provision infrastructure, in particular as it is merely necessary to distribute cryptographic keys, for example public keys of an asymmetrical cryptography system or symmetrical keys of a symmetrical cryptography system, to end users (subscribers) for checking and/or verifying the digital signature (verification key) of the data field with the subsequent address and/or as it is merely necessary to distribute cryptographic keys, for example private keys of an asymmetrical cryptography system or symmetrical keys of a symmetrical cryptography system, to end users (subscribers) for the decryption (decryption keys) of the data field with the subsequent address. Data provision may advantageously be realized in a decentralized manner, for example directly from a data generation device into the blockchain or into the distributed ledger. A data pickup may advantageously be realized in a decentralized manner, for example directly from the blockchain or from the distributed ledger by a subscriber.

The data generation device is in particular implemented as a sensor device with at least one sensor. However, alternatively other data generation devices are conceivable, like for example simulation modules, data processing modules or the like. The sensor device is in particular configured to generate in a sensor data generation step electronic data, which are realized as electronic sensor data. The electronic data are in particular realized as continuous data (e. g. streaming data, like a video stream and/or an audio stream) or as discrete data (e. g. consecutive measuring points). The data transmission network is in particular realized at least partially as a wireless data transmission network and/or at least partially as a wire-bound data transmission network. The data transmission network preferably comprises a plurality of data generation devices, which in each case execute data generation steps and provision steps. For example, the data transmission network may be embodied as an intranet or as the Internet. By a “data package” is in particular a data unit to be understood which is closed in itself and is transmitted via the data transmission network by a sender (for example the sensor device. Preferably the data package has a defined form and/or a defined size.

“Configured” is in particular to mean specifically programmed, designed and/or equipped. By an object being configured for a certain function is in particular to be understood that the object fulfills and/or executes said certain function in at least one application state and/or operation state.

By the data packages being written directly into the blockchain or directly into the distributed ledger, is in particular to be understood that when the data packages are transmitted, the data generation device creates a direct connection to the blockchain or the distributed ledger, which is preferably free of a central data-storage backend, in particular a backend of a client-server application, a backend of a database application and/or a backend of a content management system. By the data packages being provided directly from the blockchain or directly from the distributed ledger, is in particular to be understood that upon receipt of the data packages the subscribers of the data packages build a direct connection to the blockchain or the distributed ledger, into which the data packages were fed by the data generation device beforehand. In particular, the blockchain constitutes a special implementation of the distributed ledger technology. In particular, the distributed ledger may be realized as a blockchain. A “blockchain” is in particular to mean a continuously expandable list of datasets linked to one another by means of cryptographic procedures, wherein each of these datasets comprises at least a cryptographically secure hash value of the preceding dataset, a timestamp and transaction data. Preferably each of the provided data packages comprises the data field with the reference to the subsequent address. However, it is generally also conceivable that only every nth data package comprises a data field with references to the following n data packages. The subsequent address in particular indicates a network address in the data transmission network, for example an internet address, under which the data package following the data package will come up and will be available for download. It is conceivable that the data field also comprises a time information indicating when the data package following the data package will come up and will thus be available for download. A “data field” is in particular to mean a smallest unit, in particular a smallest evaluable unit, of a data set, in particular of a data package. A “reference” is in particular to mean an electronic reference, for example a hyperlink or a web link. Using the blockchain and/or the distributed ledger advantageously allows creating a high level of manipulation safety of the data. Advantageously, in particular by using the distributed ledger and/or the blockchain, decentral operation is achievable.

By a “digitally signed data field” is in particular a data field to be understood which was signed digitally using a symmetrical cryptosystem or using an asymmetrical cryptosystem. In the asymmetrical cryptosystem a value (a digital signature), in particular of the data generation device, is preferably calculated for the data field with the assistance of a secret signature key (the private key), which is in particular stored in the data generation device. This allows each subscriber who has the corresponding public verification key (the public key) in his possession to check on the basis of this value a non-deniable authenticity and integrity of the reference to the subsequent address. In the symmetrical cryptosystem a value (a digital signature), in particular of the data generation device, is preferably calculated for the data field with the assistance of a key (in the following also referred to as the symmetrical key). This allows each subscriber who has the symmetrical key in his possession to check on the basis of this value a non-deniable authenticity and integrity of the reference to the subsequent address. By an “encrypted data field” is in particular a data field to be understood which was digitally encrypted, in particular by means of the asymmetrical cryptosystem or by means of the symmetrical cryptosystem. Each subscriber who when using the asymmetrical cryptosystem has the corresponding private decryption key (private key) in his possession or who when using the symmetrical cryptosystem has the symmetrical key in his possession will be able to use this for reading the reference to the subsequent address from the data field. It is in particular conceivable that besides the data field with the reference to the subsequent address further data fields or entire data packages are digitally signed and/or encrypted.

It is further proposed that the electronic data are provided in the provision step via a subscriber channel, which is in particular access-controlled. This advantageously enables decentralized data provision. It is advantageously possible to dispense with a central backend in which the data are stored and via which the data are distributed. This advantageously allows saving energy resources and/or computing resources. Moreover, it is in this way advantageously possible to substantially reduce a risk of data manipulation (for example at the central storage location). Dispensing with the central backend further allows saving of costs. In particular, beyond this advantageous access control is enabled via a subscriber channel. By a “subscriber channel” is in particular a digital channel to be understood via which regular obtainment of electronic data generated by the data generation device and provided by the data generation device as data packages is offered and/or realized. In particular, it is conceivable that available subscriber channels are indicated to a user on a digital end device, like for example a smartphone or a tablet computer, via an application software (app). The app is in that case only configured to arrange for the subscriber channels to be found but does not offer datasets for download or the like. It is in particular conceivable that a user may take out or terminate a subscription for the subscriber channel via the app. In particular, the channel is realized as an IOTA MAM (Masked Authenticated Messaging) channel, in particular a “restricted” IOTA MAM channel, as an IOTA streams channel or as a comparable subscriber channel. In particular, the data generation device forms a seed of the subscriber channel. In particular, the data generation device forms an IOTA seed of an IOTA MAM channel or of an IOTA streams channel. The subscriber channel is advantageously publicly distributable, for example via the app and/or via the Internet. In particular, the subscriber channel is allocated directly to a defined data generation device. In particular, the subscriber channel is started and/or administrated by the owner of the data generation device via a software of the data generation device. In particular, the respective data generation device can be geographically located and found.

Furthermore, it is proposed that the electronic data are provided in the provision step in real time or almost in real time, in particular all over the world. This allows attaining particularly high currentness of the electronic data. Advantageously this allows using the electronic data, for example, for efficient and/or effective, preferably direct controlling of systems which receive and/or process the electronic data. The term “almost in real time” is in particular to mean within less than 2 s, preferably less than 1 s and preferentially less than 0.5 s. In particular, the offset, which is maximally in a range of seconds, between a data generation by the data generation device and a data reception by a subscriber of the electronic data is mostly due to the duration of the data transfer and/or of the calculations required for adding and/or removal of the electronic data to/from the blockchain or the distributed ledger.

It is also proposed that a cryptographic key matching at least with the encryption and/or with the digital signature, in particular the decryption key and/or the verification key, is changed in regular or irregular time intervals, which are preferably situated in a single-digit, two-digit or three-digit minute range. This advantageously allows achieving a particularly high level of data security, in particular data access security and/or data authenticity security. For example, an owner of a key that has become invalid due to the key change will no longer be able to verify or decrypt the electronic data he receives from the subscriber channel when the key has become invalid. Preferably the owner of the key that has become invalid due to the key change will no longer be able to find the electronic data when the key has become invalid, as he can no longer identify subsequent addresses. In particular, the key (e. g. the public key or the symmetrical key), by means of which the electronic data, in particular at least the data field with the reference to the subsequent address, are encrypted, preferably encrypted by the data generation device, changes in a same time interval as the decryption key and/or the verification key. It is conceivable that the decryption key and the verification key are identical.

In addition, it is proposed that in a key supply step at least the respective currently valid cryptographic key matching at least with the encryption and/or with the digital signature of the encrypted and/or digitally signed data field of the currently provided data package, in particular the respective currently valid verification key suitable for the verification of the digital signature of the digitally signed data field of the currently provided data package and/or the respective currently valid decryption key suitable for the decryption of the encrypted data field of the currently provided data package, is supplied by an, in particular central, key supply system, preferably in real time or almost in real time, to a subscriber system receiving the electronic data. In this way advantageous verifiability of the electronic data and/or advantageous access control of the electronic data are/is enabled. Advantageously a particularly high level of data security is achievable. Herein in particular, when the currently valid verification key and/or decryption key is changed, the new verification key and/or decryption key is supplied in real time or almost in real time. In particular, the new verification key and/or the new decryption key are/is transmitted to the subscriber system via the data transmission network. In particular, the new verification key and/or the new decryption key are/is supplied to all subscriber systems which are authorized for this. The key supply system may in particular be realized as the app. It is moreover conceivable that an access to the verification keys and/or to the decryption keys is implemented on a distributed ledger or on a blockchain or on a distributed storage system by means of distributed identities (“decentralized identifiers” DID). In particular, herein the verification keys and/or the decryption keys are made accessible only to the owner of the DIDs, using the cryptographic methods stored in the DIDs; the verification keys and/or the decryption keys are for example encrypted by means of a public key assigned to the DID and then stored on a distributed ledger or on a blockchain. Advantageously, in such a case the central key supply system could be dispensed with. In particular, the data generation device sends for this purpose the respectively currently valid verification keys and/or encryption keys to the app or to the providers of the app for distribution to the authorized subscriber systems. In particular, the app mostly, preferably merely, serves for supplying keys and for searchable publishing of the subscriber channels.

If at least the cryptographic key matching with the decryption and/or with the digital signature of the encrypted and/or digitally signed data field of the currently provided data package, in particular the respective currently valid verification key suitable for the verification of the digital signature of the digitally signed data field of the currently provided data package and/or the respective currently valid decryption key suitable for the decryption of the encrypted data field of the currently provided data package, is transmitted automatically by the, in particular central, key supply system for a predefined limited time period to a subscriber system that is registered with the subscriber channel, especially advantageous access control is enabled.

Advantageously, a particularly high level of data security is attainable. The predefined limited time period preferably corresponds to a time period of a subscriber system's subscription for the subscriber channel. For example, the predefined limited time period comprises one or several week/s, one or several month/s or one or several year/s.

Beyond this it is proposed that the electronic data, in particular at least the data fields of the data packages of the electronic data comprising the references to the subsequent addresses, and/or the entire data packages of the electronic data can be decrypted and/or verified only by owners of a currently valid cryptographic key matching with the encryption and/or the digital signature of the encrypted and/or digitally signed data field of the currently provided data package. In this way particularly advantageous access control is enabled. Advantageously, a particularly high level of data security is attainable.

If, in addition to the data fields containing the references to the subsequent addresses, the remaining portion of the data packages, in particular at least portions of all further data fields of the data packages, are also encrypted and/or digitally signed, a particularly high level of data security and/or particularly advantageous access control are/is attainable.

If herein moreover a further cryptographic key, in particular a further decryption key and/or further verification key, which is suitable for the decryption of the remaining portion of the data packages, in particular at least of portions of all further data fields of the data packages, and/or for the verification of the contents of the remaining portion of the data packages, in particular at least of portions of all further data fields of the data packages, is different from the cryptographic key that is configured for the decryption of the data fields allocated to the data packages and containing the references to the subsequent addresses, in particular different from the decryption key and/or from the verification key, an even higher level of data security is advantageously attainable. However, it is alternatively also conceivable that the further data fields of the data packages can be decrypted by means of the same decryption key as the data field containing the reference to the subsequent address and/or can be verified by means of the same verification key as the data field containing the reference to the subsequent address.

It is further proposed that at least the data fields allocated to the data packages and containing the references to the subsequent addresses or the entire data packages are encrypted and/or digitally signed by the data generation device in the data generation step. As a result, advantageously a particularly high level of data security, in particular manipulation safety, is attainable. Advantageously, moreover high energy efficiency is achievable, in particular by bundling and digitally signing/encrypting the electronic data already in the data generation device instead of each individual measuring point being transmitted to an external unit separately. In particular, the data generation device comprises a data processing unit with an encryption and/or signing module which is configured for digitally signing and/or encrypting the data fields which are allocated to the data packages and contain the references to the subsequent addresses. In particular, the data processing unit comprises at least one symmetrical key or at least one public key/private key pair, preferably several public key/private key pairs, which are exchanged periodically or aperiodically.

It is also proposed that the data generation device is realized as the sensor device with the sensor and/or that the electronic data are realized as sensor data. This advantageously allows attaining a high level of data security for sensor data, in particular with regard to a verification of authenticity of consecutively provided data packages with the sensor data and/or with regard to an access control of the consecutively provided data packages with the sensor data. Advantageously, in this way a decentralized data provision infrastructure for sensor data is enabled.

Furthermore it is proposed that in a key generation step the cryptographic key matching at least with the encryption and/or with the digital signature of the encrypted and/or digitally signed data field of the data package is generated in a sensor-based manner, in particular in regular or irregular time intervals, which are preferably situated in a one-digit, two-digit or three-digit minute range, and is transmitted to the, in particular central, key supply system, in particular in the regular or irregular time intervals, which are preferably situated in a one-digit, two-digit or three-digit minute range. This advantageously allows attaining a high level of data security, in particular cryptographic data security. Advantageously, an especially autonomous system with a particularly lean backend is enabled. Alternatively it is conceivable that in an alternating manner a cryptographic key, matching with the encryption and/or with the digital signature of the encrypted and/or digitally signed data field of the data package, is selected from a plurality of cryptographic keys which are pre-installed on the data generation device and is transmitted to the key supply system. The term “in a sensor-based manner” is in particular to mean directly on the sensor or on a system that is closely linked up with the sensor and is arranged in a proximity of the sensor, for example a local data forwarding station, like a LoRaWAN gateway.

Beyond this it is proposed that at least one consensus protocol for the feeding into the blockchain or into the distributed ledger, for example a Proof-of-Work (POW), a Proof-of-Stake (PoS), in particular a consensus protocol based on elections and/or a leader-based consensus protocol, like a Delegated Proof-of-Stake (DPoS) or a Raft algorithm or the like, is carried out by the data generation device, in particular in a sensor-based manner, or is carried out by an, in particular sensor-external, data forwarding system of the data transmission network, which is different from the data generation device. In this way advantageously an at least largely decentralized data provision infrastructure is enabled. Advantageously, this allows achieving a high level of data security, in particular with regard to manipulation. Advantageously, especially high efficiency is achievable in terms of energy, resources and/or costs. In particular, it is conceivable that requirements regarding an effort necessary for a consensus protocol that is to be absolved, for example for a Proof-of-Work, are made dependent on a reputation procedure. In particular, the requirement for the effort necessary for the consensus protocol that is to be absolved could be made dependent on a participation history, in particular of the data generation device and/or of the data forwarding system, in the data transmission network. In particular, the requirement concerning the effort necessary for the consensus protocol could be made dependent on an activity, in particular of the data generation device and/or of the data forwarding system, in the data transmission network. In particular, the requirement concerning the effort necessary for the consensus protocol that is to be absolved could be made dependent on numbers and/or types of crypto values held in particular by the data generation device and/or the data forwarding system. In particular, the requirement concerning the effort necessary for the consensus protocol that is to be absolved, in particular by the data generation device and/or the data forwarding system, could be made dependent on an actual load on the data transmission network. The data forwarding system of the data transmission network is in particular realized as a local gateway, for example as a LoRaWAN gateway, which is configured for collecting and forwarding (low-energy) signals from sensors which are locally distributed over an area, preferably forwarding said signals to that portion of the data transmission network for which the subscriber system can obtain access. Preferably the data forwarding system is arranged at a distance of few kilometers, preferably of a few hundred meters, from the data generation device. In particular, the data forwarding system is assigned explicitly to at least one data generation device. In particular, the data transmission network comprises a plurality of data forwarding systems which are respectively assigned to different data generation systems, which are preferably arranged in different regions.

In this context it is further proposed that the data forwarding system, which is different from the data generation device, is realized so as to be different and separate from a backend, in particular different and separate from a backend of a client-server application, a backend of a database application and/or a backend of a Content Management System, and preferably different and separate from a control station. In this way advantageously a data provision infrastructure is enabled which is at least largely decentralized. Advantageously, a particularly lean data provision infrastructure is enabled. It is advantageously possible to attain a high level of data security, in particular manipulation safety. Preferably the data provision method is at least substantially free of a backend, in particular of a data storage backend. If a backend is provided within the data provision method, this backend is limited to an administration and/or transmission of the cryptographic keys, to an administration of user accounts that can be registered with the subscriber channel and/or to a geographical search and/or presentation of positions of data generation devices that can be subscribed for.

It is moreover proposed that automatic obtainment of the electronic data by the subscriber system, preferably a subscriber system's subscription for the subscriber channel, is terminated automatically if the subsequent address contained in a received data package, in particular the data field with the reference to the subsequent address which is contained in a received data package, cannot be decrypted by a cryptographic key, in particular the decryption key, that is currently available to the subscriber system. In this way particularly advantageous access control is achievable. Advantageously, especially simple access control is achievable. Advantageously, particularly comprehensive control of the data streams transmitted via the data transmission network is attainable.

If alternatively or additionally an automatic verification of the received electronic data of a data stream, in particular by the subscriber system, preferably an assignment of a certificate of authenticity to the received data by the subscriber system, is terminated if the digital signature of a data field contained in one of the received data packages, in particular of the data field with the subsequent address, cannot be verified by a cryptographic key, in particular the verification key, which is currently available to the subscriber system, an advantageously high level of forgery safety and/or manipulation safety is achievable. In particular, moreover the automatic obtainment of the electronic data by the subscriber system, preferably a subscription of the subscriber system for the subscriber channel, is terminated automatically if the data field with the reference to the subsequent address which is contained in a received data package cannot be verified by a verification key currently available to the subscriber system. Preferably, a warning notification is outputted by the subscriber system if a received data package cannot be verified. In the case of non-verifiability of data packages of a data stream, the data stream, in particular the chain of data packages, would possibly remain publicly receivable and/or readable (in particular if there is no additional encryption of the data packages or of individual data fields of the data packages as the subsequent address is in such a case stored in clear text), there would be no possibility of proving without doubt provenience and/or authenticity of the data and/or integrity and/or completeness of the data stream.

Furthermore, it is proposed that in a remuneration step, on receipt of a data package, preferably upon each receipt of an individual data package of a data stream, a digital payment, in particular a digital micro payment, is initiated to an address belonging to the data generation device or to an owner address, which is for example contained in the digital data, in particular an address of an owner of the data generation device. Advantageously, in this way direct remuneration is enabled to a data generator, in particular to the owner of the data generation device. As a result, an intermediary agent, for example a provider of a data storage backend, may advantageously be dispensed with. Advantageously, this generally allows dispensing with the backend. Advantageously, in this way self-amortization of the data generation device is enabled. Advantageously, particularly exact remuneration is enabled. A “micropayment” is in particular to mean a remuneration which amounts to a fraction of a smallest currency unit common in an economic area. For example, in the Euro economic area a sum below EUR 0.01 is to be understood as a micropayment. For example, for receipt of a data package, in particular of a measuring value of the sensor, a remuneration is initiated to the amount of one hundredth or several hundredths of a Eurocent or of a thousandth or several thousandths of a Eurocent to the address allocated to the data generation device or to the owner's address. Preferably the remuneration is realized in the form of a micropayment-compatible crypto currency, like IOTA.

It is further proposed that the sensor is embodied as an, in particular stationary, agricultural sensor. This advantageously allows providing agricultural sensor data in real time or almost in real time. Advantageously, in this way prompt and/or selective reaction to transmitted measuring values in the field of agriculture is enabled.

Alternatively or additionally it is proposed that the sensor is embodied as an infrastructure sensor, in particular as a traffic management sensor. This advantageously allows providing traffic sensor data in real time or almost in real time. In this way, for example, prompt and/or selective reaction to transmitted measuring values in the field of traffic is enabled.

Beyond this a sensor network is proposed, which is configured for carrying out the data provision method, with a data generation device or several data generation devices which is/are realized as (a) sensor device/s. Advantageously, this allows attaining a high level of data security, in particular regarding a verification of authenticity of consecutively provided data packages and/or regarding access control of the consecutively provided data packages. Moreover, a decentralized data provision infrastructure is advantageously enabled. A “sensor network” is in particular to mean a computer network of sensor devices, preferably of computers communicating via radio, which cooperate either in an infrastructure-based network (key word: gateway) or in a self-organizing ad-hoc network in order to obtain information from their environment by means of the sensors and to forward the information. For this purpose, the sensor network preferably comprises one or several sensor(s) generating the sensor data, the data transmission network for an external provision of the sensor data, and an access control system which is configured to make the subscriber channel publicly available for direct obtainment of the sensor data from the sensor(s), and at least the subscriber system, which is registered with the subscriber channel and obtains the sensor data directly from the sensor(s). The access control system is in particular embodied as a smartphone, as a tablet or as a further personal computer, on which at least the app is installed, preferably pre-installed.

In addition, the sensor, in particular the agricultural sensor or the infrastructure sensor, for the sensor network is proposed.

The data provision method according to the invention, the sensor network according to the invention and/or the sensor according to the invention shall herein not be limited to the application and implementation described above. In particular, in order to fulfill a functionality that is described here, the data provision method according to the invention, the sensor network according to the invention and/or the sensor according to the invention may comprise a number of individual method steps, elements, components and units which differs from a number given here.

### DRAWINGS

Further advantages will become apparent from the following description of the drawings. In the drawings an exemplary embodiment of the invention is illustrated. The drawings, the description and the claims contain a plurality of features in combination. Someone skilled in the art will purposefully also consider the features separately and will find further expedient combinations.

It is shown in:

FIG. 1 a schematic illustration of a sensor network with several data generation devices,

FIG. 2 a schematic illustration of the electronic data generated by the data generation devices, and

FIG. 3 a schematic flow chart of a data provision method running via the sensor network.

### DESCRIPTION OF THE EXEMPLARY EMBODIMENT

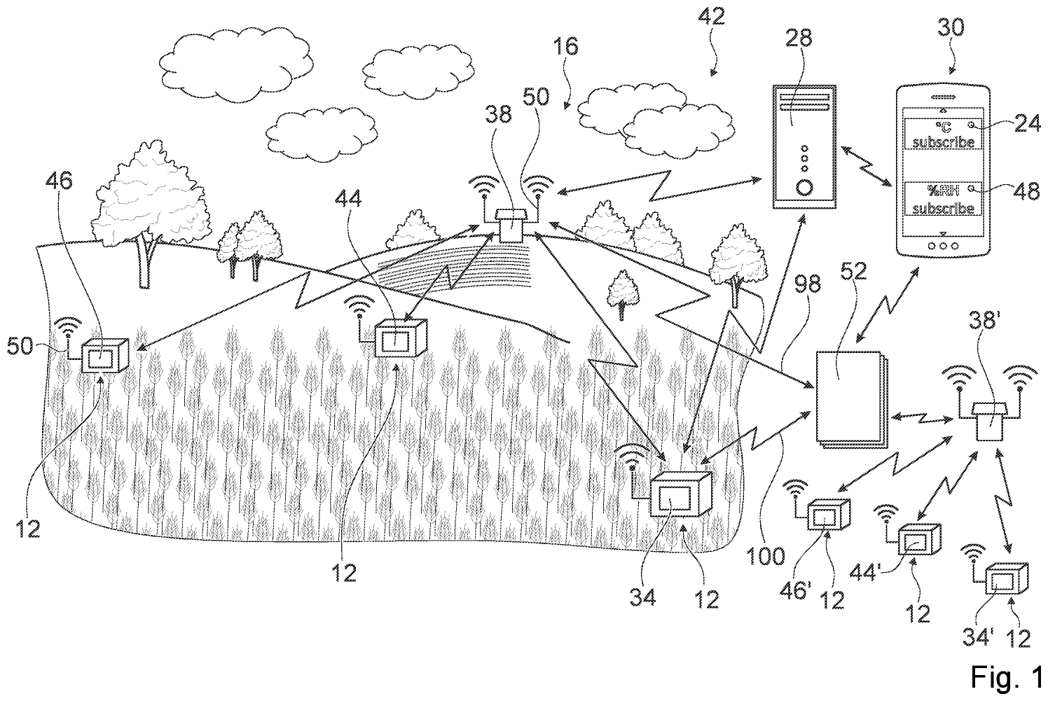

FIG. 1 shows a schematic illustration of a sensor network 42. The sensor network 42 comprises several data generation devices 12. The data generation devices 12 are embodied as sensor devices. Each of the data generation devices 12 comprises at least one sensor 34, 34′, 44, 44′, 46, 46′. The sensors 34, 34′, 44, 44′, 46, 46′ shown in FIG. 1 are exemplarily realized as stationary agricultural sensors which are arranged so as to be distributed over an area used for agricultural purposes. Alternatively, the sensors 34, 34′, 44, 44′, 46, 46′ could be realized as mobile agricultural sensors, as infrastructure sensors (not shown), like for example traffic management sensors, or as any further sensors of a sensor network 42. The sensors 34, 34′, 44, 44′, 46, 46′ may be realized, for example, as optical sensors (e. g. camera sensors, radar sensors, etc.), as acoustical sensors (e. g. microphones), as environment condition sensors (e. g. temperature sensors, humidity sensors, air pressure sensors, rainfall quantity sensors, wind force sensors, wind direction sensors, ground humidity sensors, fog density sensors, traffic-counting sensors, etc.) or as any further kind of sensors registering at least one physics parameter. The data generation devices 12 each comprise a radio module 50, which is configured for sending electronic data and/or receiving electronic data. By way of example, the radio module 50 is embodied as a LoRa radio module. Data transmission via alternative data transmission protocols, like for example mobile radio protocols (GSM, etc.), is of course also conceivable. The sensor network 42 implements a data transmission network 16. The data generation devices 12 form part of the data transmission network 16. The data transmission network 16 is configured for an external provision of the electronic data. In the example described here, the electronic data are realized as sensor data.

The data transmission network 16 comprises data forwarding systems 38, 38′. The data forwarding systems 38, 38′ are embodied as LoRaWAN gateways. The data forwarding systems 38, 38′ are realized different and separate from the data generation devices 12. The data forwarding systems 38, 38′ are realized different and separate from a backend in which the electronic data are stored temporarily. A data forwarding system 38, 38′ is in each case assigned to a plurality of data generation devices 12. The data forwarding systems 38, 38′ each comprise a radio module 50, which is configured for sending electronic data and/or receiving electronic data. The data forwarding system 38, 38′ is configured to feed the electronic data of the data generation devices 12 arranged in a near environment (few kilometers) of the respective data forwarding system 38, 38′ into the Internet. The data forwarding systems 38, 38′ are configured to write the electronic data of the data generation devices 12 arranged in a near environment (few kilometers) of the respective data forwarding system 38, 38′ into a blockchain or into a distributed ledger 52 (see arrow 98). Alternatively, the data generation devices 12 may be realized independently from data forwarding systems 38, 38′ and may be capable of writing the electronic data directly into the blockchain or into the distributed ledger 52 (see arrow 100).

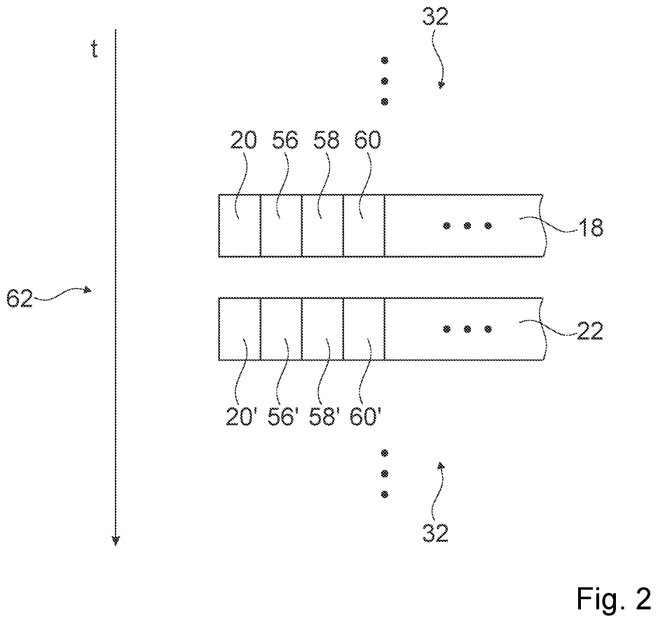

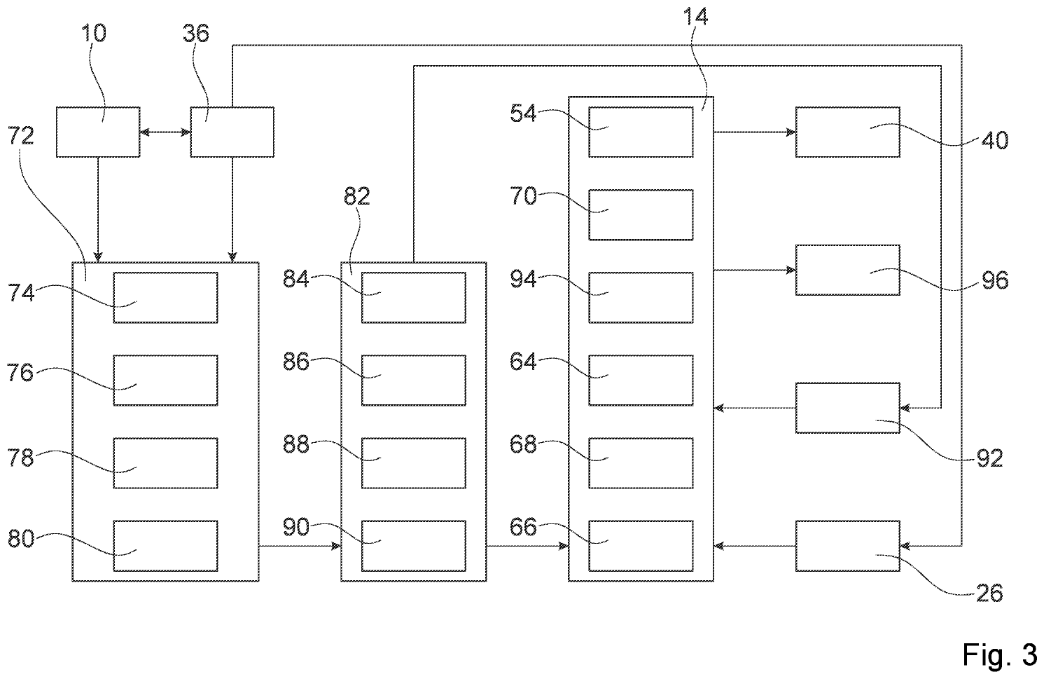

The sensor network 42 comprises an access-control system 48. The access-control system 48 is realized as an app. Via the access-control system 48 a geographic position of the respective data generation devices 12 can be found. The geographic positions of the data generation devices 12 are retrievable via the access-control system 48. The access-control system 48 is configured to make a subscriber channel 24 publicly available for direct obtainment of the sensor data from the sensors 34, 34′, 44, 44′, 46, 46′. The sensor network 42 is connected to a subscriber system 30 via the access-control system 48. In the example shown in FIG. 1, the subscriber system 30 is embodied as a smartphone. The subscriber system 30 is configured to receive, display and/or evaluate the electronic data. The subscriber system 30 is configured to obtain the electronic data via the blockchain or the distributed ledger 52 directly from the sensors 34, 34′, 44, 44′, 46, 46′. The subscriber system 30 can be registered with the subscriber channel 24 via the access-control system 48. The subscriber system 30 obtains the electronic data via the subscriber channel 24. Each subscriber channel 24 is assigned to one or several data generation devices 12 and/or data forwarding systems 38, 38′. Each subscriber channel 24 exclusively enables obtainment of the electronic data provided by data generation devices 12 and/or by data forwarding systems 38, 38′ which are explicitly assigned to the respective subscriber channel 24. The data generation devices 12 are configured to generate the electronic data illustrated schematically in FIG. 2. The sensor network 42 is configured to carry out a data provision method shown in FIG. 3.

The sensor network 42 communicates with a central key supply system 28. The key supply system 28 may also be integrated in the sensor network 42. The key supply system 28 is configured for receiving cryptographic keys, in particular public keys, private keys or symmetrical keys, preferably decryption keys or verification keys, from the data generation devices 12 and/or from the data forwarding systems 38, 38′. The key supply system 28 is configured for storing the cryptographic keys, in particular the public keys, the private keys or the symmetrical keys, preferably the decryption keys or the verification keys. The key supply system 28 is configured for transmitting cryptographic keys, in particular public keys, private keys or symmetrical keys, preferably decryption keys or verification keys, to the subscriber systems 30, in particular to subscriber systems 30 registered with the subscriber channel 24. The key supply system 28 transmits the cryptographic keys, in particular public keys, private keys or symmetrical keys, preferably decryption keys or verification keys, exclusively to active subscribers of a subscriber channel 24. The key supply system 28 transmits exclusively the cryptographic keys, in particular public keys, private keys or symmetrical keys, preferably decryption keys or verification keys, which belong to the data generation devices 12 and/or to the data forwarding systems 38, 38′ of the respective subscriber channel 24. The key supply system 28 is embodied as a central server with a storage and a processor. Alternatively, the key supply system 28 could be embodied as a distributed server or could be implemented by means of DIDs in a decentralized manner via the blockchain or the distributed ledger 52.

FIG. 2 shows a schematic illustration of the electronic data generated by the data generation devices 12. The electronic data are implemented as electronic datasets and/or as electronic data streams 62, which in each case comprise data packages 18, 22. The data packages 18, 22 are realized so as to be temporally consecutive, having a finite size and a uniform structure. Each data package 18, 22 comprises one or several data field(s) 56, 56′, 58, 58′, 60, 60′ with usage data (e. g. the measured sensor data). Each data package 18, 22 comprises a data field 20, 20′ with a reference to a subsequent address. The subsequent address may be determined randomly or quasi-randomly. The subsequent address indicates the place (link) where the next data package 22 following a data package 18 is to be found or will be to be found, in particular where or how to download the next data package 22 from the blockchain or from the distributed ledger 52. The data field 20, with the subsequent address is encrypted and digitally signed. However, it is alternatively also conceivable that the data field 20, 20′ with the subsequent address is only encrypted but not digitally signed, or is only digitally signed but not encrypted. In addition to the data fields 20, 20′ with the references to the subsequent addresses, a remaining portion 32 of the data packages 18, 22 is also encrypted and/or digitally signed. The data fields 20, 20′ with the references to the subsequent addresses and/or the remaining portions 32 of the data packages 18, 22 are also digitally signed and/or encrypted by the data generation devices 12. The data generation devices 12 in each case comprise internal data processing units (not shown) with at least one data storage and with at least one processor. The internal data processing units of the data generation devices 12 comprise an operation program which is retrievable from the storage unit by the processor and is configured for encrypting and/or digitally signing the data fields 20, 20′ with the references to the subsequent addresses and/or the remaining portions 32 of the data packages 18, 22.

FIG. 3 shows a schematic flow chart of the data provision method. The data provision method comprises a data generation step 10. In the data generation step the electronic data are generated by the data generation devices 12 on the basis of the measurements of the sensors 34, 34′, 44, 44′, 46, 46′. In the data generation step 10 a detection signal from the internal data processing unit of the data generation devices 12 is converted into an electronic dataset comprising the data packages 18, 22 (see FIG. 2) and/or into an electronic data stream 62 comprising the data packages 18, 22. In a cryptography step 72 the data packages 18, 22 are encrypted and/or digitally signed by the data generation device 12. In at least one sub-step 74 of the cryptography step 72 the data fields 20, 20′ with the references to the subsequent addresses of the data packages 18, 22 are respectively encrypted by means of a key (e. g. a public key or a symmetrical key) of the data generation device 12. In at least one sub-step 76 of the cryptography step 72 the data fields 20, with the references to the subsequent addresses of the data packages 18, 22 are respectively digitally signed by means of a key (e. g. a private key or a symmetrical key) of the data generation device 12. The key for the encryption and the key for the digital signature may be identical to each other or different from each other. In at least one sub-step 78 of the cryptography step 72 of the cryptography step 72 the remaining portions 32 of the data packages 18, 22 are encrypted by a key (e. g. a public key or a symmetrical key) of the data generation device 12. In at least one sub-step 80 of the cryptography step 72 the remaining portions 32 of the data packages 18, 22 are digitally signed by a key (e. g. a private key or a symmetrical key) of the data generation device 12. The keys used for the encryption and for the digital signature may then be identical to or different from each other, and/or may be identical to or different from the keys for the encryption and the digital signature of the data fields 20, 20′ with the subsequent addresses. The electronic data encrypted and/or digitally signed in this way are decryptable and/or verifiable only by owners of a currently valid cryptographic key matching with the encryption and/or with the digital signature of the encrypted and/or digitally signed data field 20, 20′ of the currently provided data package 18, 22.

In at least one further cryptography step 82 the cryptographic keys matching with the currently generated data packages 18, 22 are changed in regular or irregular time intervals, which are preferably situated in a one-digit, two-digit or three-digit minute range. For example, the cryptographic keys matching with the currently generated data packages 18, 22 are changed in 10-minute intervals. In a sub-step 84 of the further cryptography step 82 the cryptographic key matching with the encryption of the data field 20, 20′ with the subsequent address of the currently generated data package 18, 22, in particular the decryption key, for the data field 20, 20′ with the subsequent address is changed in regular or irregular time intervals, which are preferably situated in a one-digit, two-digit or three-digit minute range. In a further sub-step 86 of the further cryptography step 82 the cryptographic key matching with the digital signature of the data field 20, 20′ with the subsequent address of the currently generated data package 18, 22, in particular the verification key, for the data field 20, 20′ with the subsequent address is changed in regular or irregular time intervals, which are preferably situated in a one-digit, two-digit or three-digit minute range. In a further sub-step 88 of the further cryptography step 82 the cryptographic key matching with the encryption of the remaining portion 32 of the currently generated data package 18, 22, in particular the decryption key for the remaining portion 32 of the currently generated data package 18, 22, is changed in regular or irregular time intervals, which are preferably situated in a one-digit, two-digit or three-digit minute range. In a further sub-step 90 of the further cryptography step 82 the cryptographic key matching with the digital signature of the remaining portion 32 of the currently generated data package 18, 22, in particular the verification key for the remaining portion 32 of the currently generated data package 18, 22, is changed in regular or irregular time intervals, which are preferably situated in a one-digit, two-digit or three-digit minute range.

In at least one provision step 14 the electronic data are provided as the data packages 18, 22 via the data transmission network 16. In a sub-step 54 of the provision step 14 the data packages 18, 22 are written directly into the blockchain or into the distributed ledger 52 via the data transmission network 16. In a further sub-step 70 of the provision step 14 at least one consensus protocol for the feeding into the blockchain or into the distributed ledger 52 is carried out by the data generation device 12. In a further sub-step 94 of the provision step 14, which is an alternative to the sub-step 70, the consensus protocol for the feeding into the blockchain or into the distributed ledger 52 is carried out by the sensor-external data forwarding system 38, 38′ of the data transmission network 16, which is different from the data generation device 12.

In a further sub-step 64 of the provision step 14 the electronic data are provided via the subscriber channel 24 (see FIG. 1). The subscriber channel 24 may be access-controlled. It is for example conceivable that a subscription for the subscriber channel 24 can be taken out only against payment of an amount of money, only after linking up with a payment system (e. g. with a cryptocurrency wallet) or only after entering certain data (e. g. name and address) etc. In at least one further sub-step 68 of the provision step 14 the subscriber system 30 is registered with the subscriber channel 24 by a user for an obtainment of the electronic data of the data generation devices 12 linked to the subscriber channel 24.

In a further sub-step 66 of the provision step 14 the data packages 18, 22 are provided via the data transmission network 16 directly from the blockchain or from the distributed ledger 52 for retrieval by the subscriber system 30. The data packages 18, 22 are thus retrievable and/or downloadable by the subscriber systems 30 directly from the blockchain or directly from the distributed ledger 52. In the provision step 14 the electronic data are provided via the subscriber channel 24 in real time or almost in real time.

In a key generation step 36 the cryptographic keys matching with the encryption and/or with the digital signature of the data fields 20, 20′, 56, 56′, 58, 58′, 60, 60′ of the data package 18, 22 are generated in a sensor-based manner, in particular by the data generation devices 12 or by the data forwarding systems 38, 38′. In the key generation step 36 moreover the cryptographic keys matching with the encryption and/or with the digital signature of the data fields 20, 20′, 56, 56′, 58, 58′, 60, 60′ of the data package 18, 22 are transmitted to the key supply system 28.

In a key supply step 26 the respective currently valid cryptographic keys matching with the encryptions and/or with the digital signatures of the data fields 20, 20′, 56, 56′, 58, 58′, 60, 60′ of the data package 18, 22, in particular the matching decryption keys and/or the matching verification keys, are supplied by the key supply system 28 to the subscriber system 30 receiving the electronic data. The respectively matching cryptographic keys are supplied to the subscriber system 30 in real time or almost in real time. In the key supply step 26 the cryptographic keys matching with the encryption and/or with the digital signature of the data fields 20, 20′, 56, 56′, 58, 58′, 60′ of the currently provided data package 18, 22 are automatically transmitted by the key supply system 28 for a predefined limited time period to the subscriber system 30 that is registered with the subscriber channel 24. The predefined limited time period herein corresponds to the time period in which the data fields 20, 20′, 56, 56′, 58, 58′, 60, 60′ of the generated data packages 18, 22 are encrypted or digitally signed by means of a key matching therewith (e. g. a public key, a private key or a symmetrical key). If there is a change of the cryptographic key that is necessary and/or suitable for the decryption or verification of the currently provided data package 18, 22, said change being carried out in the further cryptography step 82, the changed cryptographic key, which is now the matching cryptographic key, is in a further key supply step 92 following the key supply step 26 transmitted to the subscriber system 30 that is registered with the subscriber channel 24.

In at least one further method step 96 a subscription for the subscriber channel 24 is terminated by a user of the subscriber system 30. In this case, if there is a change of a cryptographic key matching with at least one data field 20, 20′, 56, 56′, 58, 58′, 60, of the data package 18, 22, no new changed key will be transmitted to the subscriber system 30. Thus, the further key supply step 92 will not be executed any longer for this subscriber system 30. The automatic obtainment of the electronic data by the subscriber system 30, i. e. the subscription taken out by the subscriber system 30 for the subscriber channel 24, will be automatically terminated if the subsequent address contained in a received data package 18, 22 cannot be decrypted by a cryptographic key that is currently available to the subscriber system 30. In this case, due to the lack of information regarding the subsequent addresses, the further data packages 18, 22 cannot be found by the subscriber system 30 anymore. Even if the current cryptographic key is at a later time reset to a previously valid cryptographic key, the subscription will remain inactive. Furthermore, the automatic verification of the received electronic data of a data stream 62 is terminated if the digital signature of at least one data field 20, 20′, 56, 56′, 58, 58′, 60′ contained in one of the received data packages 18, 22 cannot be verified by a cryptographic key that is currently available to the subscriber system 30. In this case it is possible that the further data packages 18, 22 can still be found by the subscriber system 30—unless the data fields 20, 20′ with the subsequent addresses carry an additional encryption—however, the subscriber system 30 can no longer trust these electronic data as a verification of the data packages 18, 22 is no longer possible.

Upon receipt of each of the data packages 18, 22, a digital payment is initiated to an address belonging to the data generation device 12 or to the address of an owner of the data generation device 12 in a remuneration step 40. The digital payment is herein realized in the form of digital micro payments. The digital payment is realized in a cryptocurrency.

In the following an exemplary remuneration process will be described. First of all, a price for a measuring value and/or for a data package 18, 22 is stored on the data generation device 12. For example, a temperature measuring value of a data generation device 12 embodied as an agricultural sensor, which is determined every two minutes, costs EUR 0.0001. If a subscriber makes a selection via the access-control system 48, buying for example, for 60 minutes, temperature data from 1,000 data generation devices 12 which are arranged in a distributed manner and have different owners (private persons, enterprises, etc.), respectively if the subscriber registers his subscriber system 30 with the subscriber channels 24 assigned to the data generation devices 12, this will cost the subscriber EUR 0.10 every two minutes, that is EUR 3.00 in total. At least a portion of the EUR 3.00 are transmitted and distributed gradually (EUR 0.10 every two minutes) from the subscriber to the owners (owner addresses) of the 1,000 distributedly-arranged data generation devices 12. It is conceivable that a portion of the EUR 3.00 is transmitted to the access-control system 48 (the app) for making the subscriber channels 24 publicly available. In return, the subscriber will for 60 minutes receive the respectively valid cryptographic keys matching with the electronic data of the 1,000 distributedly-arranged data generation devices 12 from the key supply system 28. When the 60 minutes are finished, the subscriber will no longer receive updates of the cryptographic keys, such that obtainment of the electronic data is automatically terminated as the subscriber system 30 is no longer able to determine the subsequent addresses of the further data packages. Advantageously the subscriber may be provided with a simple total account (for example for all subscriptions together) via the access-control system 48 (the app). The owners of the data generation devices 12 may advantageously be provided with a precise account via the access-control system 48 (the app).

At the same time any number of further subscribers may also obtain the electronic data of the 1,000 distributedly-arranged data generation devices 12 or at least of a portion of these data generation devices 12, in particular with no increased load being generated on the side of the data generation devices 12. Advantageously, the subscriber and the owners of the data generation devices 12 do not need to know each other. Advantageously, the subscriber and a provider of the key supply system 28 or of the access-control system 48 (the app) do not need to know each other. Advantageously, the owners of the data generation devices 12 and a provider of the key supply system 28 or of the access-control system (the app) do not need to know each other. Beyond this, there are advantageously no contracts necessary between the owners of the data generation devices 12 and the subscribers. It is merely required that an agreement concerning the utilization of the access-control system 48 is agreed to on the subscriber's side and/or on the side of the owners of the data generation devices 12.

1. A data provision method, with a data provision step in which electronic data are generated by at least one data generation device, and with a provision step in which the electronic data are provided in the form of data packages via a data transmission network, wherein in the provision step the data packages are first of all, preferably directly, written into a blockchain or into a distributed ledger, and wherein in the provision step the data packages are provided, preferably directly, from the blockchain or from the distributed ledger via the data transmission network, wherein provided data packages comprise at least one encrypted and/or digitally signed data field with a reference to an, in particular random or quasi-random, subsequent address of the next data package following the data package.

2. The data provision method according to claim 1, wherein the electronic data are provided in the provision step via a subscriber channel, which is in particular access-controlled.

3. The data provision method according to claim 1, wherein the electronic data are provided in the provision step in real time or almost in real time.

4. The data provision method according to claim 1, wherein a cryptographic key matching at least with the encryption and/or with the digital signature is changed in regular or irregular time intervals, which are preferably situated in a single-digit, two-digit or three-digit minute range.

5. The data provision method according to claim 1, wherein in a key supply step at least the respective currently valid cryptographic key matching at least with the encryption and/or with the digital signature of the encrypted and/or digitally signed data field of the currently provided data package is supplied by an, in particular central, key supply system, preferably in real time or almost in real time, to a subscriber system receiving the electronic data.

6. The data provision method according to claim 2, wherein at least the cryptographic key matching with the encryption and/or with the digital signature of the encrypted and/or digitally signed data field of the currently provided data package is transmitted automatically by an, in particular central, key supply system for a predefined limited time period to a subscriber system that is registered with the subscriber channel.

7. The data provision method according to claim 1, wherein the electronic data can be decrypted and/or verified only by owners of a currently valid cryptographic key matching with the encryption and/or with the digital signature of the encrypted and/or digitally signed data field of the currently provided data package.

8. The data provision method according to claim 1, wherein in addition to the data fields containing the references to the subsequent addresses, the respective remaining portion of the data packages is also encrypted and/or digitally signed.

9. The data provision method according to claim 8, wherein a further cryptographic key suitable for the decryption of the remaining portions of the data packages and/or for the verification of the contents of the remaining portions of the data packages is different from a cryptographic key that is configured for the decryption of the data fields allocated to the data packages and containing the references to the subsequent addresses.

10. The data provision method according to claim 1, wherein at least the data fields allocated to the data packages and containing the references to the subsequent addresses or the entire data packages are encrypted and/or digitally signed by the data generation device in the data generation step.

11. The data provision method according to claim 1, wherein the data generation device is realized as a sensor device with a sensor and/or that the electronic data are realized as sensor data.

12. The data provision method according to claim 11, wherein in a key generation step the cryptographic key matching at least with the encryption and/or with the digital signature of the encrypted and/or digitally signed data field of the data package is generated in a sensor-based manner and is transmitted to the key supply system.

13. The data provision method according to claim 1, wherein at least one consensus protocol for the feeding into the blockchain or into the distributed ledger is carried out by the data generation device.

14. The data provision method according to claim 1, wherein at least one consensus protocol for the feeding into the blockchain or into the distributed ledger is carried out by an, in particular sensor-external, data forwarding system of the data transmission network, which is different from the data generation device.

15. The data provision method according to claim 14, wherein the data forwarding system, which is different from the data generation device, is realized so as to be different and separate from a backend.

16. The data provision method according to claim 6, wherein automatic obtainment of the electronic data by the subscriber system, preferably a subscription of the subscriber system for the subscriber channel, is terminated automatically if the subsequent address contained in a received data package cannot be decrypted by means of a cryptographic key currently available to the subscriber system.

17. The data provision method according to claim 6, wherein an automatic verification of the received electronic data of a data stream is terminated if the digital signature of a data field contained in one of the received data packages cannot be verified by a cryptographic key currently available to the subscriber system.

18. The data provision method according to claim 1, wherein in a remuneration step upon receipt of a data package a digital payment, in particular a digital micro payment, is initiated to an address belonging to the data generation device or to an owner address.

19. The data provision method according to claim 11, wherein the sensor is embodied as an, in particular stationary, agricultural sensor.

20. The data provision method according to claim 11, wherein the sensor is embodied as an infrastructure sensor, in particular as a traffic management sensor.

21. A sensor network, which is configured for carrying out the data provision method according to claim 1, with a data generation device or several data generation devices realized as (a) sensor device/s.

22. The sensor network according to claim 21, with one or several sensor/s generating sensor data, with a data transmission network for an external provision of the sensor data, with an access-control system which is configured to make a subscriber channel publicly available for direct obtainment of the sensor data from the sensor/s, and with at least one subscriber system, which is registered with the subscriber channel and obtains the sensor data directly from the sensor/s.

23. A sensor, in particular an agricultural sensor or infrastructure sensor, for a sensor network according to claim 21.
